(19) United States
(12) Patent Application Publication
(10) Pub. No.: US 2020/0198161 A1
(43) Pub. Date: Jun. 25, 2020

(54) BLADE UNIT AND LUBRAPAD

(71) Applicant: BEIERSDORF AG, Hamburg (DE)

(72) Inventors: Peter MAURER, Neumuenster (DE); Alexander KRUEMKE, Hamburg (DE); Michaela KOHUT, Hamburg (DE); Arne SCHULTCHEN, Hamburg (DE); Andre FELDMANN, Hamburg (DE); Christine JUNG, Hamburg (DE); Armin WARNECKE, Hamburg (DE)

(21) Appl. No.: 16/631,571

(22) PCT Filed: Jul. 16, 2018
(86) PCT No.: PCT/EP2018/069316

§ 371 Date: Jan. 16, 2020

(30) Foreign Application Priority Data
Jul. 17, 2017 (DE) 10 2017 116 062.0

(51) Int. Cl. B26B 21/44; B26B 21/22; B26B 21/52; B26B 21/40

(52) U.S. Cl. CPC B26B 21/443; B26B 21/225; B26B 21/4025; B26B 21/4018; B26B 21/521

(57) ABSTRACT

A blade unit and a lubrapad for attachment to a handle of a safety razor, the blade unit comprising: a blade housing and a plurality of blades disposed within the blade housing to expose respective cutting edges suitable for shaving; the blade housing including a guard in front of the cutting edges and a cap to the rear of the cutting edges; and the lubrapad comprising: a lubrapad body comprising solid lubricating material and provided separately from the blade unit, extending along the guard and in front of the guard, the body having a greatest width and/or depth in the blade direction at the guard, the body width and/or depth reducing in a smooth convex curve away from the guard to a curved front portion of the body; wherein the blade unit and lubrapad are arranged to move independently with respect to each other.

### FIELD

Embodiments described herein relate to a blade unit and lubrapad, and a safety razor (or safety razor system) having such blade unit and lubrapad.

### BACKGROUND

Safety razors are typically composed of a blade unit (or cartridge) connected, either detachably or fixedly (permanently fixed or integrated), to an elongate handle extending essentially in the direction of shaving. A safety razor with a detachable and disposable blade unit is known as a safety razor system. Blade units are known which have one or more parallel blades perpendicular to the shaving direction and thus to the handle, each defining a cutting edge, with blade unit elements positioned in front of and behind (rear of) the cutting edge(s) (referred to as a “guard” and a “cap”, respectively) in a shaving direction. A solid shaving aid, such as a thin lubricating strip, is often incorporated into one or both of these blade unit elements. It would be desirable to provide an improved blade unit and solid shaving aid configuration.

### BRIEF SUMMARY

One embodiment of the invention provides a blade unit and a lubrapad for attachment to a handle of a safety razor, the blade unit comprising: a blade housing and a plurality of blades disposed within the blade housing to expose respective cutting edges suitable for shaving; the blade housing including a guard in front of the cutting edges and a cap to the rear of the cutting edges; and the lubrapad comprising: a lubrapad body comprising solid lubricating material and provided separately from the blade unit, extending along the guard and in front of the guard, the body having a greatest width and/or depth in the blade direction at the guard, the body width and/or depth reducing smoothly and continuously in a convex curve away from the guard to a curved front portion of the body; wherein the blade unit and lubrapad are arranged to move independently with respect to each other.

The smooth/continuous reduction of the width and depth of the lubrapad and the convex form of the gliding surface allows improved gliding across the skin of a user, with provision of the most lubrication closest to the blades.

Separating the blade unit and lubrapad, so that they can move independently from one another, allows the cutting and lubricating functions to be separated, and that allows optimization of the blade unit and lubrapad design to conform to, or follow, the contours of a user's skin. The term ‘lubrapad’ generally refers to a solid shaving aid that has lubricating properties. The lubrapad can, of course, have other properties considered beneficial during shaving such as, for example, moisturizing properties. The lubrapad can be provided ‘bare’ in that it is not contained or surrounded by any manner of housing, base, or holder. Furthermore, the lubrapad body can consist entirely of solid lubricating material or the lubricating material can form part of the body, such as a layer on the body.

The composition of the lubrapad can include a gliding agent. Materials which may be selected as the gliding agent are: PEG-400/1,4-Butanediol/SMDI Copolymer, PEG-115M, PEG 45M, and PEG-5M, or a combination thereof. The composition of the lubrapad can include an antioxidant agent, for example Tocopherol. The composition of the lubrapad can include an anti-inflammatory agent, for example aloe barbadensis leaf juice. The composition of the lubrapad can include a backbone structure. Materials which may be selected as the backbone structure are: styrenic block copolymers and polystyrene, or a combination thereof.

In one embodiment, the blade unit and/or the lubrapad is arranged to move with respect to the handle of the safety razor. This also allows the blade unit and/or the lubrapad to better conform to, or follow, the contours of a user's skin

The lubrapad and blade unit can be connected to each other and/or to the handle in different configurations. In one embodiment, the lubrapad comprises a flexible connection to the blade unit or a flexible connection to the handle, and the blade unit comprises a connection to the handle, which is preferably flexible. In one embodiment, both the lubrapad and the blade unit comprise a direct connection to the handle, one or both of the connections being a flexible connection. In one embodiment, the blade unit comprises one or more projections or tabs from a front surface of the guard, which are to be housed in recesses in a first surface portion of the lubrapad body which is directly facing the guard front surface. The lubrapad can be connectable to both blade unit and handle with such tabs. The tabs may be flexible, or they may move within the recesses.

The blade unit and/or shaving aid can be designed to allow the user to more precisely shave smaller, contoured areas like the underarm region or bikini line. For example, in one embodiment, the greatest width of the lubrapad body is not larger than the blade unit width and is preferably substantially equal to or smaller than a blade length. Furthermore, in one embodiment, the lubrapad extends to the front only of the blade unit, and does not surround the blade unit, so there is no lubrapad to the cap side of the blade unit.

In one embodiment, the blade housing comprises rounded portions at its sides, the rounded external surface portions of the blade housing ending in a straight front surface of the guard substantially at the extremities of the lubrapad body along its greatest width. This allows the blade housing to more smoothly glide over contoured areas.

In one embodiment, the lubrapad body comprises a first surface portion directly facing the guard front surface and a second (gliding) surface portion adjacent the skin-contacting side of the blade unit and making contact with the skin of a user in use, wherein the second surface portion is a curved surface portion, with a three-dimensional convex curvature in which the surface portion curves away in two directions from the centre of the part of the lubrapad body adjacent to the guard, which is the part of the lubrapad body which extends furthest towards the skin of a user in use. The curved surface may be referred to as bi-convex.

In one embodiment, the lubrapad body further comprises a third surface portion which is directed away from the skin of a user and towards the handle in use, the second surface portion extending between the first and the third surface portions. Such a wedge-like structure, where the lubrapad preferably tapers to a simple thin edge/line along the curved front portion of the lubrapad body, can provide a large surface area (i.e., the second surface portion adjacent the skin-contacting side of the blade unit) for lubricating the skin relative to the size of the lubrapad. The second and/or third surfaces can be substantially flat.

In one embodiment, the guard is ridged to stretch and orient hair at right angles to the cutting edges. Other formations, such as fins, could be alternatively or additionally employed.

In one embodiment, cross sections of the lubrapad and blade unit taken through the centre of the lubrapad and blade unit at right angles to the blades (in the shaving direction) are of substantially equal height (measured in the direction away from the user's skin in use).

One embodiment of the invention provides a safety razor comprising the aforementioned blade unit and lubrapad and a razor handle for attachment to the blade unit and to the lubrapad.

The above indicated aspects and embodiments may be combined with each other to achieve the advantageous effects as described above. Further embodiments, features, and advantages of the invention, as well as the structure and operation of the various embodiments of the invention are described in detail below with reference to the accompanying drawings.

### DESCRIPTION OF FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a perspective view of a blade unit and lubrapad from underneath (skin side);

FIG. 2 is a view of a blade unit and lubrapad from underneath, in a disassembled state;

FIG. 3 is another perspective view of the blade unit and lubrapad shown in FIG. 1, but from the top (user side);

FIG. 4 is a perspective view of another blade unit and lubrapad from underneath (skin side);

FIG. 5 is a side view of a safety razor with another blade unit and lubrapad from the side, and a view of detail of the blade unit and lubrapad;

FIG. 6 is a top view of the safety razor shown in FIG. 5;

FIG. 7 is a view of the safety razor shown in FIG. 5, from underneath;

FIG. 8 is a view of the safety razor shown in FIG. 5, from the front (facing the shaving direction);

FIG. 9 is a view of the safety razor shown in FIG. 5, from the rear (facing away from the shaving direction);

FIG. 10 is a perspective view of another blade unit and lubrapad from underneath (skin side);

FIG. 11 is a perspective view from underneath of a safety razor including the blade unit and lubrapad shown in FIG. 10; and

FIG. 12 is a perspective view of a safety razor including the blade unit and lubrapad shown in FIG. 10.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

The term “underneath” or “bottom” is used to describe features of the blade unit or lubrapad that are positioned on the skin-contacting side of the blade unit or lubrapad (i.e., on a shaving-side or underneath of the blade unit or lubrapad), and the term “top” is used to describe features of the blade unit or lubrapad that are positioned on a side opposite the skin-contacting side of the blade unit or lubrapad (i.e., on a user side or on top of the blade unit or lubrapad). The terms “front”, “rear”, and “side(s)” are used herein with reference to the shaving direction, i.e., the direction in which the blade unit and lubrapad are intended to be moved during shaving. In particular, the term “front” means facing the shaving direction, “rear” means facing in the shaving direction, and “side(s)” mean to either side in the shaving direction.

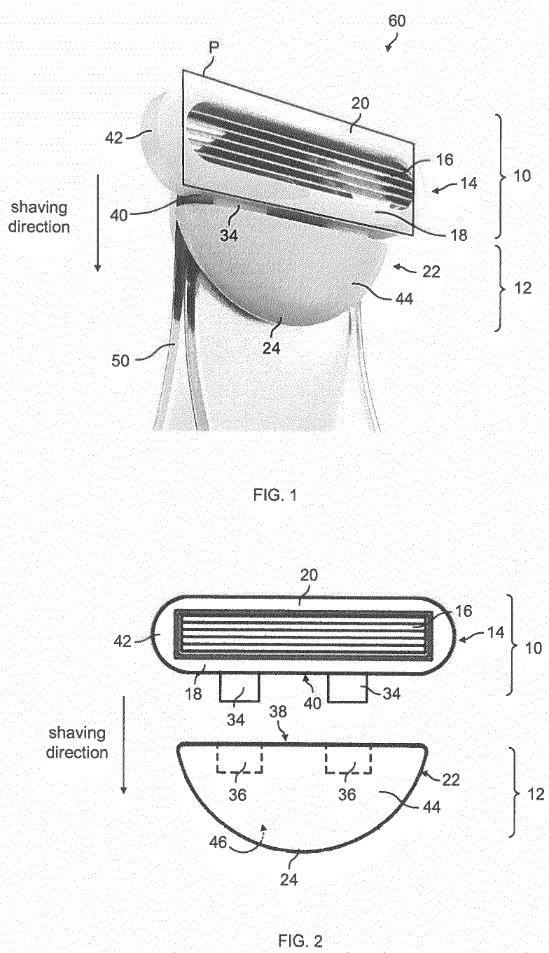

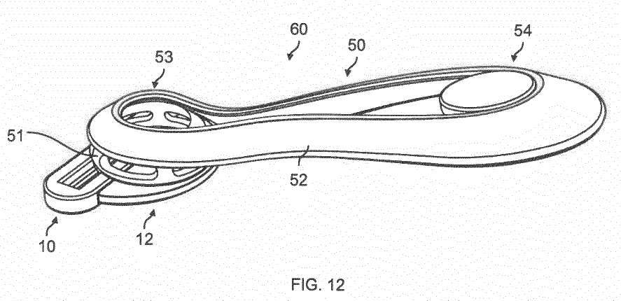

Reference will now be made to FIGS. 1 to 12, which are views of a blade unit 10 and lubrapad 12, according to embodiments. Generally speaking, the described embodiments can be differentiated from one another in terms of how the blade unit 10 and lubrapad 12 are attached to each other and/or the handle 50, which can be of different constructions, and in terms of the shape of the lubrapad 12.

FIG. 1 is a perspective from underneath the blade unit 10 and lubrapad 12. The blade unit 10 includes a guard 18, a cap 20, and rounded portions 42 that together define a blade housing 14 within which a plurality of blades 16 are disposed. The number of blades 16 can be, for example, four or five, though it can be fewer or more than this. The guard 18 is in front of the blades 16 and the cap 20 is to the rear of the blades 16. The blade unit 10 can be connected to the handle 50, either fixedly or detachably, by means of flexible connections (not shown).

The lubrapad 12 comprises a lubrapad body 22 comprising solid lubricating material. The lubrapad body 22 has a first surface portion 38 which directly faces a front surface 40 of the guard 18, a second (bottom, gliding or skin-contacting) surface portion 44 adjacent to the skin-contacting side of the blade unit 10, and a third (top) surface portion 46 generally opposite the second surface portion 44. In use, the second surface portion 44 lubricates the skin of a user and the third surface portion 46 is directed away from the skin of the user towards the handle 50. The first, second and third surface portions 38, 44, 46 of the lubrapad body 22 generally define a wedge having a curved front portion (semi-circular or partially semi-circular edge) 24 with the second surface portion 44 curving towards the curved front portion 24. The second surface portion 44 can be continuously curved toward the front portion 24 or can include a flat portion before curving towards the front portion 24. The greatest length of the third surface portion 46 in the shaving direction can be at least twice or three or four times the height of the first surface portion 38 in a direction perpendicular to the shaving plane.

FIG. 2 shows the blade unit 10 and the lubrapad 12 from underneath and separated from one another for greater clarity. As shown, the blade unit 10 has projections 34 extending from a front surface 40 of the guard 18. (The reader should recall that “front” means facing the shaving direction.) When the blade housing 10 and the lubrapad 12 are joined together, the projections 34 are (at least partly) housed in recesses 36 in a surface portion 38 of the lubrapad 22 which is directly facing the front surface 40 of the guard 18. For simplicity, the projections 34 and recess 36 are shown as rectangular in shape. These can be friction fit, threaded, glued, overmolded, or otherwise secured together. Other types of projections, for example spikes, hooks or any other suitable shapes, can be provided alternatively.

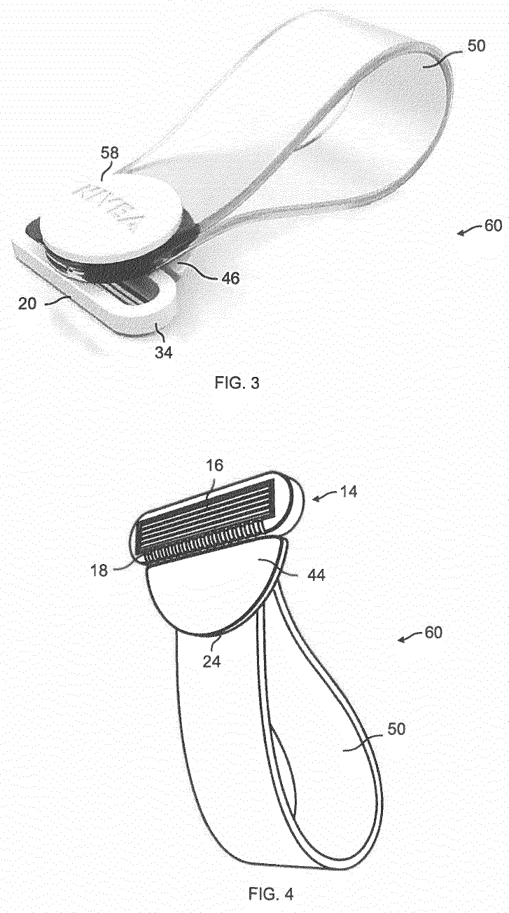

FIGS. 3 to 9 show another safety razor 60 which generally has the same construction as that shown in FIGS. 1 and 2 (with like reference numbers denoting like features), except that here the blade unit 10 and the lubrapad 12 are not connected to each other but just to the handle 50 as will be described below. FIGS. 3 and 4 are perspective views of the safety razor 60 from the top and bottom, respectively. As shown, the handle 50 is constructed from a flexible ribbon of material with attachment portions at either end of the ribbon. The ends of the ribbon are attachable together and to the blade unit 10 using a retention structure to form a loop as the handle 50. The blade housing 14 shown in FIG. 4 has a guard 18 that is ridged, in order to stretch and orient hair, at right angles to the cutting edges of the blades 16.

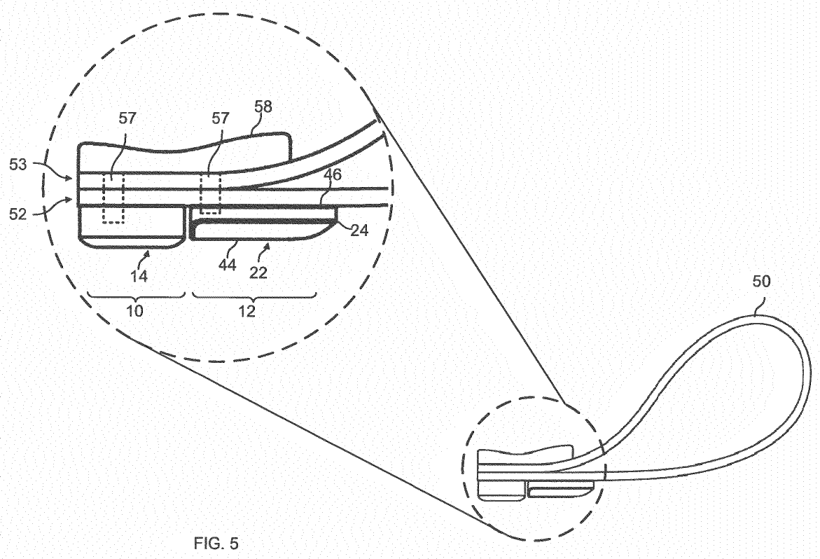

FIG. 5 shows exemplary attachment portions of the flexible ribbon in more detail. The ends of the flexible ribbon are attached together and to the blade unit 10 using a retention structure to form a loop as the handle 50. The retention structure includes two posts 57 that extend from a top plate 58 to connect to the blade unit 10 and lubrapad 12, respectively, via through-holes of attachment portions 52, 53 of the flexible ribbon. The configuration can, of course, be reversed such that the posts extend from the blade unit 10 and lubrapad 12 (or a base of the lubrapad 12). Where the blade unit 10 and lubrapad have a configuration as shown in FIGS. 1 and 2, in which the blade unit 10 and lubrapad 12 are connected to each other, then only one post 57 can be provided, for example connecting to the blade unit 10. The post(s) 57 can be secured in place by threading or friction fit, thus allowing the blade unit 10 and lubrapad 12 to be detached from the handle, or by being glued in place, or otherwise secured. Furthermore, the post(s) 57 can be dispensed with by gluing the blade unit 10 and lubrapad 12 to the handle 10.

It can also be seen from FIG. 5 that the second (bottom or skin-contacting) surface portion 44 of the lubrapad body 22 can have a flat portion adjacent to the blade housing 14 and a curved portion that tapers toward the curved front portion 24 of the lubrapad body 22. Here, the lubrapad body 22, i.e., the third (top) surface portion 46, is directly adjacent the handle 50, though alternatively the lubrapad body 22 could be mounted on a base.

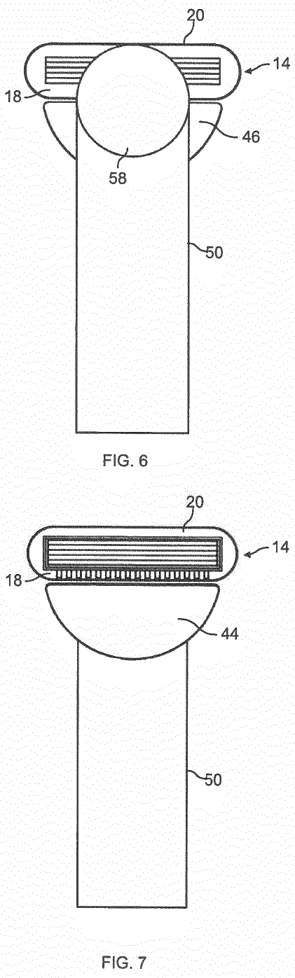

From FIGS. 6 and 7 it can be seen that the greatest width of the lubrapad body 22, which is adjacent to the guard 18, is not larger than the width of the blade unit 10. For example, the greatest width of the lubrapad body 22 can be about equal to the length of the (exposed) blade length.

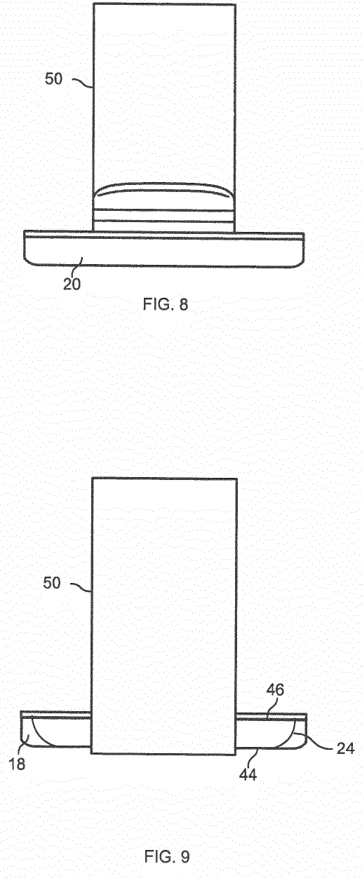

FIGS. 8 and 9 show the safety razor 60 from the front and the back, respectively. These figures show that the greatest width of the blade unit 10 and lubrapad 12 in a direction of the blades can be at least five times greater than their thickness in a direction perpendicular to the shaving plane. They also show that the second (bottom or skin-contacting) surface portion 44 adjacent to the skin-contacting side of the blade unit 10 can include a flat portion before curving towards the front portion 24.

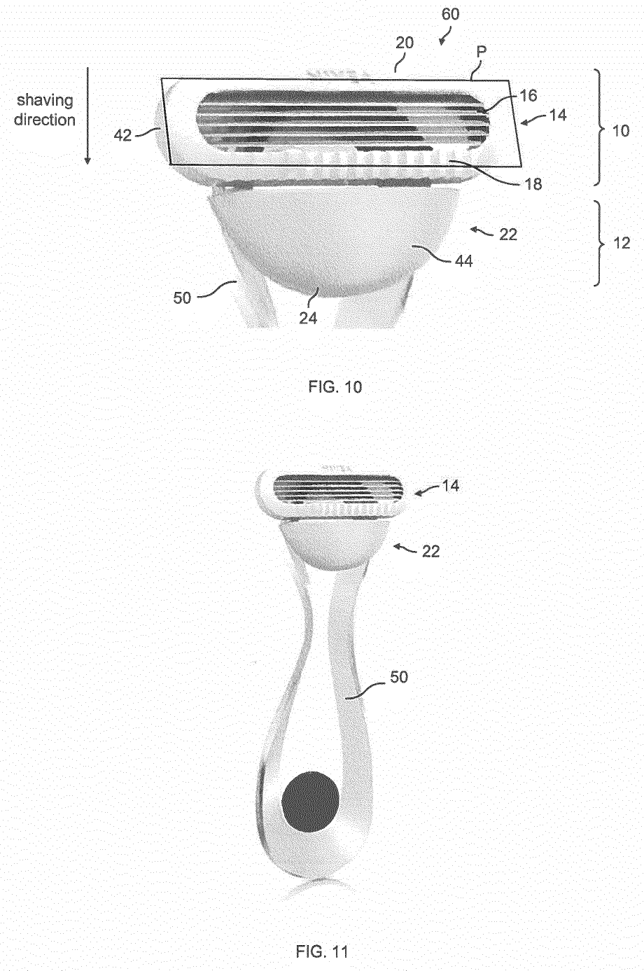

FIGS. 10 to 12 are views of a safety razor 60 having a blade unit 10, a lubrapad 12, and a handle 50. The lubrapad 12 shown in these figures generally has the same construction as that shown in FIGS. 1 and 2, though here the lubrapad body 22 does not necessarily have recesses 36 for receiving projections 34 of the blade unit 10. Rather, the blade unit 10 and the lubrapad 12 are connected to the handle 50 by a common connecting body 51. As shown, the handle 50 comprises a band of material forming a permanent endless loop 52 (in that it has no free ends) of elongate form and thus with two looped ends. One end of the loop 52 is a blade-unit loop end that is proximal to the blade unit 10, with the other end of the loop 52 being distal from the blade unit 10. The two ends of the loop 52 form a blade unit end 53 and a distal end 54 of the handle 50, respectively. The loop is smoothly curved to leave a wider gap between the sides of the loop at the ends, and a narrower gap (or no gap) between the sides of the loop away from the ends 53, 54. The connecting body 51 is housed at least partially within the loop 51 at its blade-unit loop end, i.e., at the blade unit end 53 of the handle 50. Here, the connecting body 51 is constructed as a part-spherical (frame) structure with cut-out portions. The connecting body 51 could, however, be a part-spherical structure with no cut-out portions, or even a completely spherical structure. The connecting body 51 can be configured to allow pivoting and/or rotating movement of the blade unit 11 and lubrapad 12 relative to the handle 50. The connecting body 51 can include a finger rest (not shown) at the top of the (part-) spherical structure facing away from the skin of the user and above or within the blade-unit loop end.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

### REFERENCE NUMBERS

10 blade unit
12 lubrapad
14 blade housing
16 blades
18 guard
20 cap
22 lubrapad body
24 front portion (of the lubrapad body)
34 projections
36 recesses
38 first surface portion (of the lubrapad body)
40 front surface (of the guard)
42 rounded portions (of the blade unit)
44 second surface portion (of the lubrapad body)
46 third surface portion (of the lubrapad body)
50 handle
51 connect
52 loop
53 blade unit end (of the handle)
54 distal end (of the handle)
57 posts
58 top plate
60 safety razor
P shaving plane

1.-15. (canceled)

16. A combination of a blade unit and a lubrapad for attachment to a handle of a safety razor, wherein the blade unit comprises:
a blade housing and a plurality of blades disposed within the blade housing to expose respective cutting edges suitable for shaving;
the blade housing including a guard in front of the cutting edges and a cap to a rear of the cutting edges;
wherein the lubrapad comprises:
a lubrapad body comprising solid lubricating material and provided separately from the blade unit, extending along the guard and in front of the guard, the lubrapad body having a greatest width and/or depth in a blade direction at the guard, the body width and/or depth reducing in a smooth convex curve away from the guard to a curved front portion of the body;
and wherein the blade unit and lubrapad are arranged to be capable of moving independently with respect to each other.

17. The combination of claim 16, wherein the lubrapad has no external supporting structure.

18. The combination of claim 17, wherein the lubrapad tapers to a single edge line at the front curved portion.

19. The combination of claim 16, wherein the blade unit and/or the lubrapad is arranged to move with respect to the handle of the safety razor.

20. The combination of claim 16, wherein the lubrapad comprises a flexible connection to the blade unit or a flexible connection to the handle, and the blade unit comprises a connection to the handle.

21. The combination of claim 20, wherein the connection of the blade unit to the handle is flexible.

22. The combination of claim 16, wherein both the lubrapad and the blade unit comprise a direct connection to the handle, one or both of the connections being a flexible connection.

23. The combination of claim 16, wherein the blade unit comprises one or more projections from a front surface of the guard, which are to be housed in recesses in a first surface portion of the lubrapad body which is directly facing the front surface of the guard.

24. The combination of claim 16, wherein the greatest width of the lubrapad body is not larger than a blade unit width.

25. The combination of claim 16, wherein the greatest width of the lubrapad body is substantially equal to or smaller than a blade length.

26. The combination of claim 16, wherein the lubrapad extends to the front only of the blade unit and does not surround the blade unit, so that there is no lubrapad behind the blades.

27. The combination of claim 16, wherein the blade housing comprises rounded portions at its sides, the rounded external surface portions of the blade housing ending in a straight front surface of the guard substantially at extremities of the lubrapad body along its greatest width.

28. The combination of claim 16, wherein the lubrapad body comprises a first surface portion directly facing a guard front surface and a second surface portion adjacent a skin-contacting side of the blade unit and making contact with the skin of a user in use, the second surface portion including a curved surface portion, with a three-dimensional convex curvature in which the surface portion curves away smoothly in two directions from a center of a part of the lubrapad body adjacent to the guard, which is the part of the lubrapad body which extends furthest towards the skin of a user in use.

29. The combination of claim 28, wherein the lubrapad body further comprises a third surface portion which is directed away from the skin of a user and towards the handle in use, the second surface portion extending between the first and the third surface portions.

30. The combination of claim 29, wherein a greatest length of the third surface portion in a shaving direction is at least twice a height of the first surface portion in a direction perpendicular to a shaving plane.

31. The combination of claim 29, wherein a greatest length of the third surface portion in a shaving direction is at least three times a height of the first surface portion in a direction perpendicular to a shaving plane.

32. The combination of claim 16, wherein the guard is ridged to stretch and orient hair at right angles to the cutting edges.

33. The combination of claim 16, wherein cross sections of the lubrapad and the blade unit taken through a center of the lubrapad and the blade unit at right angles to the blades in shaving direction are of substantially equal height, measured in a direction away from a user's skin in use.

34. A safety razor, wherein the razor comprises the combination of claim 16 and a razor handle for attachment to the blade unit and to the lubrapad.
